(19) United States
(12) Patent Application Publication
(10) Pub. No.: US 2016/0128019 A1
(43) Pub. Date: May 5, 2016

(54) METHOD AND MOBILE MANAGEMENT NODE FOR PAGING USER EQUIPMENTS

(71) Applicant: TELEFONAKTIEBOLAGET L M ERICSSON (PUBL), Stockholm (SE)

(72) Inventors: Zhiwei Qu, Shanghai (CN); WeN Xiang, Shanghai (CN); Zhenyu Yu, Shanghai (CN); Wei Zhang, Shanghai (CN); Zhiqiang Zhao, Shanghai (CN); Junyi Zhao, Shanghai (CN); Dongxia Zhu, Shanghai (CN)

(21) Appl. No.: 14/898,982

(22) PCT Filed: Jul. 9, 2013
(86) PCT No.: PCT/CN2013/079067

§ 371 Date: Dec. 16, 2015

(51) Int. Cl. H04W 68/04; H04W 64/00; H04W 36/08; H04W 68/02

(52) U.S. Cl. CPC H04W 68/04; H04W 68/02; H04W 64/00; H04W 36/08; H04W 88/02

(57) ABSTRACT

The embodiments disclose a method and mobility management node for paging UEs in a radio communication network. The method may comprise: acquiring history migration information indicating migration of one or more UEs from one or more original physical locations to one or more target physical locations; aggregating the history migration information to obtain statistical information on the history migration from each one of the one or more original physical locations to the one or more target physical locations; and determining a paging area based on the statistical information so as to be used for paging a specific UE.

### TECHNICAL FIELD

The present technology relates to the field of wireless communication, particularly to a method of paging user equipments (UEs) in a radio communication network. The technology also relates to a mobility management node, a computer program product, and a computer program for performing the method.

### BACKGROUND

Efficient resource utilization in radio communication networks is related to the control of the signaling load imposed by the paging operations. This relies on the application of efficient paging schemes, and on the proper planning of paging areas. Currently, a UE is usually pre-designated a paging area. For example, the paging area can be the eNodeB (eNB) last to serve the UE, the tracking area containing a plurality of eNBs that the eNB last to serve the UE belongs to, or a group of tracking areas. If the paging area comprises only one eNB, such eNB will perform the paging with respect to the UE. In this case, although the paging overhead for the radio communication network is low, the paging success rate is very low. It's very likely that the UE has moved out of the area covered this eNB. On the other hand, in the case that the paging area comprises one or more tracking areas, all the eNBs within the tracking area(s) perform the paging. Generally, the bigger the paging area is, the higher the paging success rate is. However, the paging overhead is also increased undesirably. Hence, it's badly in need of a paging scheme that improves the paging success rate while minimizes the paging load required.

### SUMMARY

An aspect of an invention disclosed herein is a method for paging UEs in a radio communication network. The method may comprise: acquiring history migration information indicating migration of one or more UEs from one or more original physical locations to one or more target physical locations; aggregating the history migration information to obtain statistical information on the history migration from each one of the one or more original physical locations to the one or more target physical locations; and determining a paging area based on the statistical information to be used for paging a specific UE.

Another aspect of the invention is a mobility management node (MMN) configured to operatively page UEs in a radio communication network. The mobility management node may comprise an acquiring unit, an aggregating unit and a determining unit. The acquiring unit is adapted to acquire history migration information indicating migration of one or more UEs from one or more original physical locations to one or more target physical locations; The aggregating unit is adapted to aggregate the history migration information to obtain statistical information on the history migration from each one of the one or more original physical locations to the one or more target physical locations; and the determining unit is adapted to determine a paging area based on the statistical information to be used for paging a specific UE.

A further aspect of the invention is a computer program product comprising the instructions which, when running on a mobility management node, causes the mobility management node to perform the steps of the method as described above.

Still a further aspect of the invention is a computer readable storage medium storing the instructions which, when running on a mobility management node, cause the mobility management node to perform the steps of the method as described above.

Through collecting the history migration information indicating migration of the UEs from original physical locations to target physical locations in the network, and determining a paging area for a specific UE based on the statistical history migration information, i.e. determining the target physical locations where the UE is to be paged, the target physical locations that the UE is more likely to move to can be found, therefore the paging success rate can be guaranteed without the expense of paging overhead.

### BRIEF DESCRIPTION OF THE DRAWINGS

The technology will now be described, by way of example, based on embodiments with reference to the accompanying drawings, wherein:

FIG. 1 illustrates a schematic view of a radio communication network environment suitable for implementing an embodiment;

FIG. 2 schematically illustrates shopping streets covered by the radio communication network;

FIG. 3 schematically illustrates a flowchart of paging UEs in the radio communication network in accordance with an embodiment; and

FIG. 4 is a block diagram of an exemplifying mobility management node configured to page UEs in the radio communication network in accordance with an embodiment.

### DETAILED DESCRIPTION

Embodiments herein will be described more fully hereinafter with reference to the accompanying drawings. The embodiments herein may, however, be embodied in many different forms and should not be construed as limiting the scope of the appended claims. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The present technology is described below with reference to block diagrams and/or flowchart illustrations of methods, apparatus (systems) and/or computer program according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling unit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present technology may be embodied in hardware and/or in software (including firmware, resident software, micro-code, etc.). Furthermore, the present technology may take the form of a computer program on a computer-usable or computer-readable storage medium having computer-usable or computer-readable program code embodied in the medium for use by or in connection with an instruction execution system. In the context of this document, a computer-usable or computer-readable storage medium may be any medium that may contain, store, or is adapted to communicate the program for use by or in connection with the instruction execution system, apparatus, or device.

Embodiments herein will be described below with reference to the drawings.

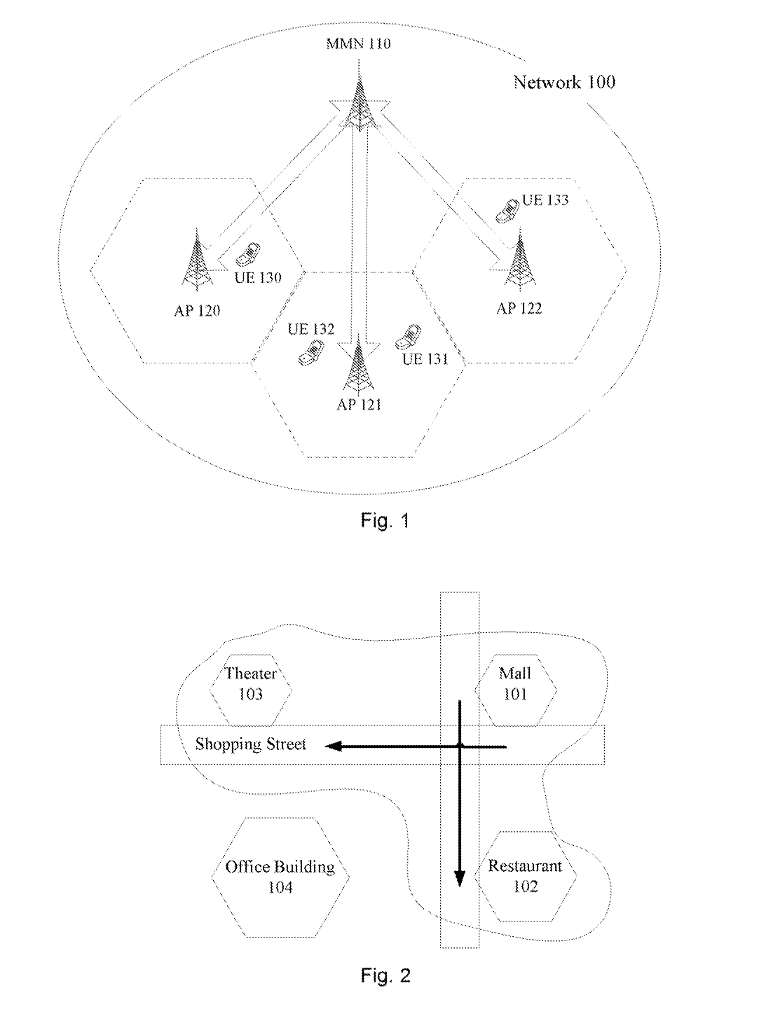

FIG. 1 illustrates a schematic view of a radio communication network environment suitable for implementing an embodiment.

As shown in FIG. 1, the radio communication network 100 comprises the Access Points (APs) 120-122 and MMN 110. The AP 120 serves the UE 130; the AP 121 serves the UE 131 and 132; and the AP 122 servers the UE 133. These UEs may roam among the areas covered by different APs. The MMN 140 may communicate with the APs, for example, so as to transmit the paging instruction.

Here, the radio communication network is applicable to, but not limited to, Time Division Long Term Evolution (TD-LTE), Global System for Mobile Communication (GSM), General Packet Radio Service (GPRS), Time Division Synchronous Code Division Multiple Access (TD-SCDMA), Wireless Fidelity (WiFi), Bluetooth, Universal Mobile Telecommunications System (UMTS), Worldwide Interoperability for Microwave Access (WiMAX), etc, and communication protocols/standards developed in the future. The term “AP” is used herein as an abbreviation for Access Point and may indicate any type of communication radio access node, such as base station, macro base station, femto base stations, NodeB, eNodeB etc. The term “UE” is used herein as an abbreviation for User Equipment and may indicate all forms of wireless devices enabling the user to communicate with APs in a radio communication network. The UE may be a smart phone, cellular phone, Personal Digital Assistant (PDA), and the like. The term “MMN” is used herein as an abbreviation for Mobility Management Node and may refer to mobility management entity (MME), Service GPRS Supporting Node (SGSN), Base Station Controller (BSC), or a Radio Network Controller (RNC) that is capable of sending out a paging request to the UEs in a paging area or at least capable of sending a paging request to another node that is capable of sending out a paging request to the UEs in a paging area.

The inventor of the present invention recognizes that, from the geographic point view, a UE may have different probability to enter into the areas covered by individual APs even if these APs belong to the same tracking area pre-designated to the UE. For example, as illustrated in FIG. 2, along the shopping streets, there are several facilities, such as the mall 101, the restaurant 102, the theater 103 and the office building 104, each of which are covered by the corresponding APs, e.g. eNB. Since this is a shopping street, it can be inferred that most of the visitors should be making a shopping. As such, for example, if a smart phone has been used to make a call or surf the Internet in the mall 101, when it is required to page such smart phone, it is more like that the smart phone will be found in the mall 101, the restaurant 102 or the theater 103 than in the office building 104, since these areas are a part of the shopping street, whereas there is the least possibility for the visitor to move from the mall 101 to the office building 104 since no shopping can be made therein. However, it is difficult to configure the paging area manually according to geographic area, and it's also challenging to figure out the geographic area coverage manually.

Nevertheless, the inventor further recognizes that the statistics of the UE migration history in the above geographic area including the shopping street may not only reflect the common user behavior but also the geographic deployment in the field, which provides the hints on optimally making the tradeoff between the paging hit rate and the signaling overhead for the paging. Subsequently, various embodiments based on this idea will be discussed in more detail.

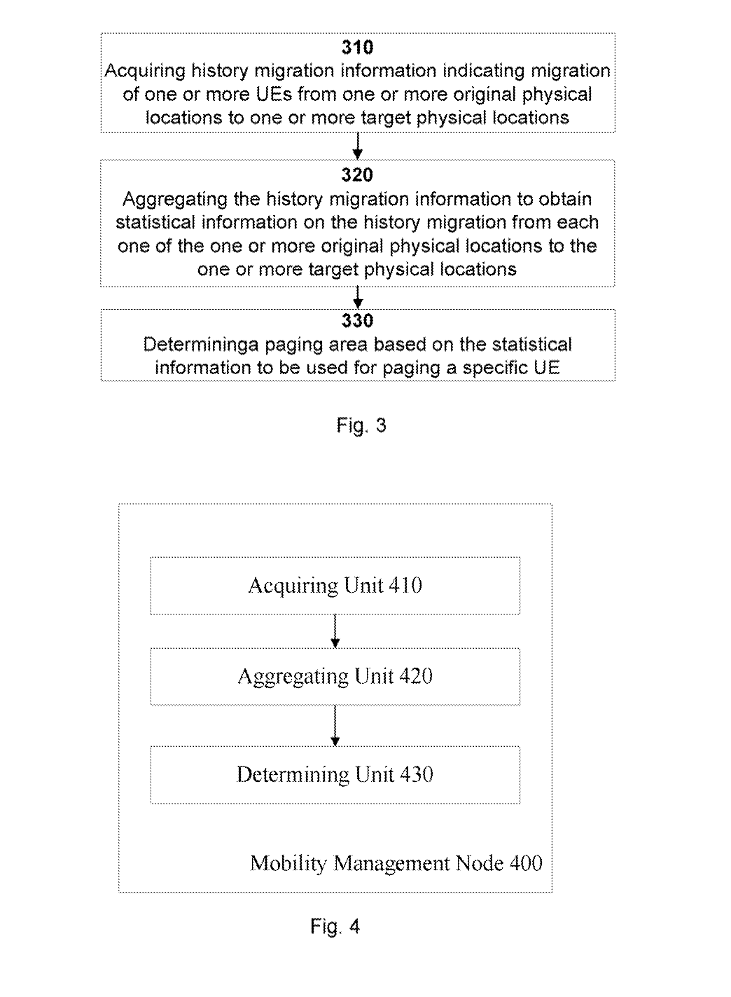

FIG. 3 schematically illustrates a flowchart of paging UEs in the radio communication network, e.g. network 100, in accordance with an embodiment. Now the process of the embodiment will be described in detail with reference to the FIG. 1 and FIG. 3.

In step 310, the MMN, e.g. MMN 110, may acquire the history migration information that indicates migration of the UEs, e.g. the UEs 130-133, from one or more original physical locations to one or more target physical locations.

Here, the history migration information may comprise a pair of the UE's original physical location and the UE's target physical location, both of which can be represented by the identities indicating the APs covering them respectively. It is possible that this pair of locations indicate the same physical location. For example, the history migration information may consist of a large amount of record items as below:

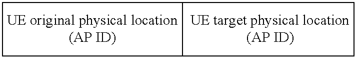

Moreover, the history migration information may further comprise the timestamp when the UE resides in the original physical location, the timestamp when the UE resides in the target physical location, and the UE's device type. The time stamp may be used to indicate the following time periods: morning, lunch time, afternoon, night life time, etc. The UE's device type, for example, can be used to indicate the people using it, such as the fashion mobile phone used by the youth, the business phone used by the professionals, and the mobile phones designed for the elder, which can be determined by the model of the UE recorded in the International Mobile Equipment Identity (IMEI).

The MMN may acquire the history migration information by monitoring and logging the migration related events, e.g. messages such as Handover Request, Path Switch Request and Service Request exchanged between the UE and/or the AP and/or the MMN. The Path Switch Request is another type of handover where two APs have direct connection via a direct interface such as the X2 interface, so MMN would be informed by the target AP serving the area that the UE is moved to. The Service Request is the indication from the UE to resume the service within the tracking area assigned by the MMN, e.g. the MME in the LTE. Additionally or alternatively, the MMN may also directly retrieve the history migration information from other radio communication networks covering the same geographic area.

It should be appreciated that the above history migration information acquirement simply are descried by way of example, and any other suitable ways to acquire the history migration information can be applied to the present invention.

In step 320, the MMN, e.g. MMN 110, may aggregate the acquired history migration information to obtain statistical information on the history migration from each one of the one or more original physical locations to the one or more target physical locations. For example, the acquired history migration information can be aggregated per the pair of the UE original physical location and the UE target physical location. Then, the MMN can obtain the times of history migration from one physical location (e.g. AP 120) to another physical location (e.g. AP 122). As a result, the history migration statistics information can be obtained as the statistical record items as below:

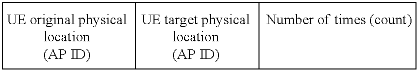

Alternatively, the MMN may aggregate the history migration information by additionally taking into account other factors as desired, such as the timestamp when the UE resides in the original physical location, the timestamp when the UE resides in the target physical location, and the UE's device type, therefore a more subdivided statistical information on the history migration can be obtained. For example, the history migration statistics information may read as below:

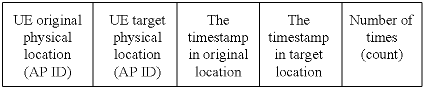

In step 330, the MMN, e.g. MMN 110, may determine a paging area based on the statistical information obtained in step 320, so as to be used for paging a specific UE, e.g. the UE 130.

Specifically, the MMN, for example, may search the history migration statistical information and find potential target physical locations based on UE related information associated with the UE 130, then select resulting target physical locations from the potential target physical locations based on a predetermined history migration criteria; and include the resulting target physical locations into the paging area

The predetermined history migration criteria may involve, but not limited to, at least one of: the count (i.e. the number of times) for the history migration from the original physical locations to the target physical locations and/or the paging cover rate for the UE 130.

In an embodiment, the UE related information may comprise the original physical location of the UE 130. The MMN 110 may determine the AP last to serve the UE 130, e.g. the AP 120, and then query the history migration statistical information by the ID of the AP 120, so as to find all the statistical records in which the AP ID representing the original physical location is equal to the ID of the AP 120. In this way, the potential target physical locations can be obtained from these statistical records, together with the corresponding count for the history migration from the physical location covered by the AP 120 to the individual potential target physical locations.

Subsequently, the MMN 110 may select the potential target physical locations, whose corresponding history migration count is above a threshold, as the resulting target physical locations. Additionally or alternatively, the MMN 110 may select the potential target physical locations, whose corresponding history migration count ranks top N (N>=1) among all the potential target physical location, as the resulting target physical locations. Additionally or alternatively, the MMN 110 may determine the resulting target physical locations based on the paging cover rate for the UE 130. For example, among all the history migration starting from the original physical location of the UE 130, i.e. the physical location covered by the AP 120, 60% of the migration is destined for the physical location covered by AP 120 (i.e. the migration happens within the physical area covered by the AP 120), 30% destined for the physical location covered by the AP 121, and 10% destined for the physical locations covered by the AP 122. As such, if the paging cover rate is required to be 50%, the MMN 140 may select only the physical location covered by AP 120 as the resulting target physical location. And if the paging cover rate is required to be 80%, then the MMN 140 may select the physical location covered by the AP 120 and the physical location covered by the AP 121 as the resulting target physical locations.

Then, these resulting target physical locations can be included into the paging area. In this way, the paging area to be used for paging the UE 130 is determined.

It should be appreciated that the paging area determination process is described by way of example. The paging area may also be determined by combining with any other suitable technical measures.

As described, the statistical history migration information may reflect the common user behavior and the geographic deployment in a specific geographic area. Hence, through collecting the history migration information indicating migration of the UEs from original physical locations to target physical locations, and determining the paging area for a specific UE based on the statistical history migration information, i.e. determining the target physical locations where the UE is to be paged, the target physical locations that the UE is more likely to move to can be found, therefore the paging success rate is guaranteed without the expense of paging load.

Optionally, the UE related information of the specific UE may further comprise at least one of the device type of the UE, the history timestamp when the UE resides in the original physical location and the current timestamp for paging the UE.

As described, the device type of the UE may indicate the people holding it, such as the fashion mobile phone used by the youth, the business phone used by the professionals, and the mobile phones designed for the elder. In other words, the device type of the UE can help determine a certain group of people having the common behaviors and habits. For example, the youth are more likely to occur in schools, while the professionals are more likely to occur in office buildings. Hence, the statistical history migration information of the UE whose device type matches with that of the UE to be paged will provide more accurate indication on the potential target physical locations.

Likewise, the history timestamp when the UE resides in the original physical location and the current timestamp for paging the UE, i.e. the timestamp when the UE resides in the target physical location, may help locate the potential target physical locations for such UE more accurately. For example, in an area mixed with commercial facilities and residence, most of the moving people in the daytime should be the visitors, but in the early morning most of them should be the residents, or in rush hour most of them should be the office staff. As seen the time stamps described above may contribute to distinguish the different groups of people, therefore the more accurate positioning of the potential target physical locations can be achieved by taking into account such timestamp(s).

Optionally, after determining the paging area to be used for paging a specific UE, e.g UE 130, as in step 330, the MMN 140 may send the paging instruction to the APs covering the resulting target physical locations included in the paging area, so as to page the specific UE, while other APs won't receive such paging instruction even if they belong to the tracing area pre-designated to the UE 130.

FIG. 4 is a block diagram of an exemplifying MMN configured to page UEs in a radio communication network in accordance with an embodiment. As illustrated in FIG. 4, the MMN 400 comprises an acquiring unit 410, an aggregating unit 420 and a determining unit 430. It should be appreciated that the MMN is not limited to the shown elements, and can comprise other conventional elements and the additional elements for other purposes. Here, the MMN 400 in FIG. 4 functions as the MMN 140 in FIG. 1. Now the functions of the individual units will be described in detail with reference to the FIG. 1 and FIG. 4.

The acquiring unit 410 of the MMN 400 may acquire the history migration information that indicates migration of the UEs, e.g. the UEs 130-133, from one or more original physical locations to one or more target physical locations.

Here, the history migration information may comprise a pair of the UE's original physical location and the UE's target physical location, both of which can be represented by the identities indicating the APs covering them respectively. It is possible that this pair of locations indicate the same physical location, that is to say, the migration happens within the area covered by the same AP. For example, the history migration information may consist of a large amount of record items as below:

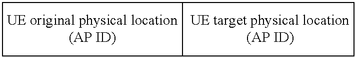

Moreover, the history migration information may further comprise the timestamp when the UE resides in the original physical location, the timestamp when the UE resides in the target physical location, and the UE's device type. The time stamp may be used to indicate the following time periods: morning, lunch time, afternoon, night life time, etc. The UE's device type, for example, can be used to indicate the people holding the UE, such as the fashion mobile phone used by the youth, the business phone used by the professionals, and the mobile phones designed for the elder, which can be determined by the model of the UE recorded in the International Mobile Equipment Identity (IMEI).

The acquiring unit 410 may acquire the history migration information by monitoring and logging the migration related events, e.g. messages such as Handover Request, Path Switch Request and Service Request exchanged between the UE and/or the AP and/or the MMN. The Path Switch Request is another type of handover where two APs have direct connection via a direct interface such as the X2 interface, so the acquiring unit 410 would be informed by the target AP serving the area that the UE is moved to. The Service Request is the indication from the UE to resume the service within the tracking area assigned by the MMN, e.g. the MME in the LTE. Additionally or alternatively, the acquiring unit 410 may also directly retrieve the history migration information from other radio communication networks covering the same geographic area.

It should be appreciated that the above history migration information acquirement simply are descried by way of example, and any other suitable ways to acquire the history migration information can be applied to the present invention.

The aggregating unit 420 may aggregate the acquired history migration information to obtain statistical information on the history migration from each one of the one or more original physical locations to the one or more target physical locations. For example, the acquired history migration information can be aggregated per the pair of the UE original physical location and the UE target physical location. Then, the MMN can obtain the times of history migration from one physical location (e.g. AP 120) to another physical location (e.g. AP 122). As a result, the history migration statistics information can be obtained as the statistical record items as below:

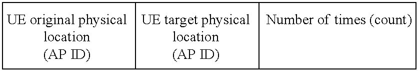

Alternatively, the aggregating unit 420 may aggregate the history migration information by additionally taking into account other factors as desired, such as the timestamp when the UE resides in the original physical location, the timestamp when the UE resides in the target physical location, and the UE's device type, therefore a more subdivided statistical information on the history migration can be obtained. For example, the history migration statistics information may read as below:

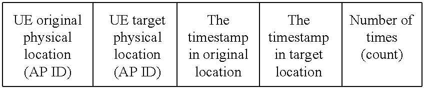

The determining unit 430 may determine a paging area based on the statistical information obtained by the aggregating unit 420, so as to be used for paging a specific UE, e.g. the UE 130.

Specifically, the MMN, for example, may search the history migration statistical information and find potential target physical locations based on UE related information associated with the UE 130, then select resulting target physical locations from the potential target physical locations based on a predetermined history migration criteria; and include the resulting target physical locations into the paging area.

The predetermined history migration criteria may involve, but not limited to, at least one of: the count (i.e. the number of times) for the history migration from the original physical locations to the target physical locations and/or the paging cover rate for the UE 130.

In an embodiment, the UE related information may comprise the original physical location of the UE 130. The determining unit 430 may determine the AP last to serve the UE 130, e.g. the AP 120, and then query the history migration statistical information by the ID of the AP 120, so as to find all the statistical records in which the AP ID representing the original physical location is equal to the ID of the AP 120. In this way, the potential target physical locations can be obtained from these statistical records, together with the corresponding count for the history migration from the physical location covered by the AP 120 to the individual potential target physical locations.

Subsequently, the determining unit 430 may select the potential target physical locations, whose corresponding history migration count is above a threshold, as the resulting target physical locations. Additionally or alternatively, the determining unit 430 may select the potential target physical locations, whose corresponding history migration count ranks top N (N>=1) among all the potential target physical locations, as the resulting target physical locations. Additionally or alternatively, the determining unit 430 may determine the resulting target physical locations based on the paging cover rate for the UE 130. For example, among all the history migration starting from the original physical location of the UE 130, i.e. the physical location covered by the AP 120, 60% of the migration is destined for the physical location covered by AP 120 (i.e. the migration happens within the physical area covered by the AP 120), 30% destined for the physical location covered by the AP 121, and 10% destined for the physical locations covered by the AP 122. As such, if the paging cover rate is required to be 50%, the determining unit 430 may select only the physical location covered by AP 120 as the resulting target physical location. And if the paging cover rate is required to be 80%, then the determining unit 430 may select the physical location covered by the AP 120 and the physical location covered by the AP 121 as the resulting target physical locations.

Then, the determining unit 430 can include these resulting target physical locations into the paging area. In this way, the paging area to be used for paging the UE 130 is determined.

It should be appreciated that the paging area determination process is described by way of example. The paging area may also be determined by combining with any other suitable technical measures.

As described, the statistical history migration information may reflect the common user behavior and the geographic deployment in a specific geographic area. Hence, through collecting the history migration information indicating migration of the UEs from original physical locations to target physical locations, and determining the paging area for a specific UE based on the statistical history migration information, i.e. determining the target physical locations where the UE is to be paged, the target physical locations that the UE is more likely to move to can be found, therefore the paging success rate is guaranteed without the expense of paging load.

Optionally, the UE related information of the specific UE may further comprise at least one of the device type of the UE, the history timestamp when the UE resides in the original physical location and the current timestamp for paging the UE.

As described, the device type of the UE may indicate the people holding it, such as the fashion mobile phone used by the youth, the business phone used by the professionals, and the mobile phones designed for the elder. In other words, the device type of the UE can help determine a certain group of people having the common behaviors and habits. For example, the youth are more likely to occur in schools, while the professionals are more likely to occur in office buildings. Hence, the statistical history migration information of the UE whose device type matches with that of the UE to be paged will provide more accurate indication on the potential target physical locations.

Likewise, the history timestamp when the UE resides in the original physical location and the current timestamp for paging the UE, i.e. the timestamp when the UE resides in the target physical location, may help locate the potential target physical locations for such UE more accurately. For example, in an area mixed with commercial facilities and residence, most of the moving people in the daytime should be the visitors, but in the early morning most of them should be the residents, or in rush hour most of them should be the office staff. As seen the time stamps described above may contribute to distinguish the different groups of people, therefore the more accurate positioning of the potential target physical locations can be achieved by taking into account such timestamps.

Optionally, after the determining unit 430 determines the paging area to be used for paging a specific UE, e.g UE 130, the MMN 400 may be configured to send the paging instruction to the APs covering the resulting target physical locations included in the paging area, so as to page the specific UE, while other APs won't receive such paging instruction even if they belong to the tracing area pre-designated to the UE 130.

Some of the embodiments described above may be summarized in the following manner:

One exemplifying embodiment is directed to a method in a mobility management node for paging UEs in a radio communication network. The method comprises the actions of:
acquiring history migration information indicating migration of one or more UEs from one or more original physical locations to one or more target physical locations;
aggregating the history migration information to obtain statistical information on the history migration from each one of the one or more original physical locations to the one or more target physical locations;
determining a paging area based on the statistical information to be used for paging a specific UE.

In the history migration information, the original physical location may be represented by a first identity indicating a first AP covering the original physical location, and the target physical locations may be represented by a second identity indicating a second AP covering the target physical location.

The paging area may be determined by:
searching the statistical information and finding potential target physical locations based on UE related information associated with the specific UE;
selecting resulting target physical locations from the potential target physical locations based on a predetermined history migration criteria; and
including the resulting target physical locations into the paging area.

The specific UE related information may comprise at least one of:
the original physical location of the specific UE; and/or
the device type of the specific UE; and/or
the history timestamp that the specific UE resides in the original physical location; and/or
the current timestamp for paging the specific UE.

The predetermined history migration criteria may involve at least one of: the count for the history migration from the original physical locations to the target physical locations and/or the paging cover rate for the specific UE.

The method indicated above may further comprise the action of instructing the APs covering the resulting target physical locations to page the specific UE.

Another exemplifying embodiment is directed to a mobility management node configured to operatively page user equipments, UEs, in a radio communication network. The mobility management node comprises:
an acquiring unit adapted to acquire history migration information indicating migration of one or more UEs from one or more original physical locations to one or more target physical locations;
an aggregating unit adapted to aggregate the history migration information to obtain statistical information on the history migration from each one of the one or more original physical locations to the one or more target physical locations;
a determining unit adapted to determine a paging area based on the statistical information to be used for paging a specific UE.

In the history migration information, the original physical location may be represented by a first identity indicating a first AP covering the original physical location, and the target physical locations may be represented by a second identity indicating a second AP covering the target physical location.

The determining unit may be adapted to search the statistical information and find potential target physical locations based on UE related information associated with the specific UE, and select resulting target physical locations from the target physical locations based on a predetermined history migration criteria, and include the resulting target physical locations into the paging area.

The specific UE related information may comprise at least one of:
the original physical location of the specific UE; and/or
the device type of the specific UE; and/or
the history timestamp that the specific UE resides in the original physical location; and/or
the current timestamp for paging the specific UE.

The predetermined history migration criteria may involve at least one of: the count for the history migration from the original physical locations to the target physical locations and/or the paging cover rate for the specific UE.

The mobility management node may further comprise an instructing unit adapted to instruct the APs covering the resulting target physical locations to page the specific UE.

The acquiring unit may be adapted to acquire the history migration information based on at least one of the message of Handover Required and/or Path Switch Request and/or Service Request between the UE and the AP.

While the embodiments have been illustrated and described herein, it will be understood by those skilled in the art that various changes and modifications may be made, any equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1. A method in a mobility management node for paging user equipments, UEs, in a radio communication network, comprising:
acquiring history migration information indicating migration of one or more UEs from one or more original physical locations to one or more target physical locations;
aggregating the history migration information to obtain statistical information on the history migration from each one of the one or more original physical locations to the one or more target physical locations; and
determining a paging area based on the statistical information to be used for paging a specific UE.

2. The method according to claim 1, wherein, in the history migration information, the original physical location is represented by a first identity indicating a first access point, AP, covering the original physical location, and the target physical locations is represented by a second identity indicating a second AP covering the target physical location.

3. The method according to claim 1, wherein the paging area is determined by:
searching the statistical information and finding potential target physical locations based on UE related information associated with the specific UE;
selecting resulting target physical locations from the potential target physical locations based on a predetermined history migration criteria; and
including the resulting target physical locations into the paging area.

4. The method according to claim 3, wherein the specific UE related information comprises at least one of:
the original physical location of the specific UE; and/or
the device type of the specific UE; and/or
the history timestamp that the specific UE resides in the original physical location; and/or
the current timestamp for paging the specific UE.

5. The method according to claim 3, wherein the predetermined history migration criteria involves at least one of: the count for the history migration from the original physical locations to the target physical locations and/or the paging cover rate for the specific UE.

6. The method according to claim 3, the method further comprises instructing the APs covering the resulting target physical locations to page the specific UE.

7. The method according to claim 1, wherein the acquiring the history migration information comprises acquiring the history migration information based on at least one of the message of Handover Required and/or Path Switch Request and/or Service Request between the UE and the AP.

8. A mobility management node configured to operatively page user equipments, UEs, in a radio communication network, comprising:
an acquiring unit adapted to acquire history migration information indicating migration of one or more UEs from one or more original physical locations to one or more target physical locations;
an aggregating unit adapted to aggregate the history migration information to obtain statistical information on the history migration from each one of the one or more original physical locations to the one or more target physical locations; and
a determining unit adapted to determine a paging area based on the statistical information to be used for paging a specific UE.

9. The mobility management node according to claim 8, wherein, in the history migration information, the original physical location is represented by a first identity indicating a first access point, AP, covering the original physical location, and the target physical locations is represented by a second identity indicating a second AP covering the target physical location.

10. The mobility management node according to claim 8, wherein the determining unit is adapted to search the statistical information and find potential target physical locations based on UE related information associated with the specific UE, and select resulting target physical locations from the target physical locations based on a predetermined history migration criteria, and include the resulting target physical locations into the paging area.

11. The mobility management node according to claim 10, wherein the specific UE related information comprises at least one of:
the original physical location of the specific UE; and/or
the device type of the specific UE; and/or
the history timestamp that the specific UE resides in the original physical location; and/or
the current timestamp for paging the specific UE.

12. The mobility management node according to claim 10, wherein the predetermined history migration criteria involves at least one of: the count for the history migration from the original physical locations to the target physical locations and/or the paging cover rate for the specific UE.

13. The mobility management node according to claim 10, the mobility management node further comprises an instructing unit adapted to instruct the APs covering the resulting target physical locations to page the specific UE.

14. The mobility management node according to claim 8, wherein the acquiring unit is adapted to acquire the history migration information based on at least one of the message of Handover Required and/or Path Switch Request and/or Service Request between the UE and the AP.

15. (canceled)

16. (canceled)
